(19) United States
(12) Patent Application Publication
(10) Pub. No.: US 2008/0160434 A1
(43) Pub. Date: Jul. 3, 2008

(54) Toner for Developing Electrostatic Latent Image and Image Forming Method

(75) Inventors: Keita Sensui, Tokyo (JP); Hiroto Kidokoro, Tokyo (JP)

Correspondence Address: KRATZ, QUINTOS & HANSON, LLP, 1420 K Street, N.W., Suite 400, WASHINGTON, DC, 20005, US

(73) Assignee: Zeon Corporation, Tokyo (JP)

(21) Appl. No.: 11/792,827

(22) PCT Filed: Dec. 13, 2005
(86) PCT No.: PCT/JP05/22866

§ 371 Date: Jun. 12, 2007

(30) Foreign Application Priority Data
Dec. 17, 2004 (JP) 2004-366881

(51) Int. Cl. G03G 13/14; G03G 9/09

(52) U.S. Cl. 430/48; 430/108.1

(57) ABSTRACT

The present invention provides a toner for developing an electrostatic latent image which is capable of obtaining sufficient image density and preventing transfer failure even in a state that a toner is likely to be deficient in charge amount or charge distribution such as when the consumption rate of toner is high or in the early stage of printing.

A toner for developing an electrostatic latent image is a toner comprising a colored particle containing a colorant and a binder resin, wherein a work function X (eV) of the toner obtained in measuring work function and a gradient A (1/eV) of a normalized photoelectron yield with respect to an excitation energy calculated from a formula “normalized photoelectron yield/excitation energy” are in the ranges of 5.35<X<5.60 and A−55X+290>0, is disclosed.

### TECHNICAL FIELD

The present invention relates to a toner for developing an electrostatic latent image (hereinafter, it may be simply referred to as “a toner”) used for development of a latent image with electrostatic properties such as an electrostatic latent image, a magnetic latent image or the like in electrophotography, the electrostatic recording method, the electrostatic printing method, the magnetic recording method or the like. Particularly, the present invention relates to a toner for developing an electrostatic latent image capable of obtaining sufficient image density and preventing transfer failure.

The present invention also relates to an image forming method using the above-mentioned toner for developing an electrostatic latent image.

### BACKGROUND ART

Electrophotography is a method of obtaining a printed product by steps of: developing an electrostatic latent image formed on a photosensitive member with a toner for developing an electrostatic latent image comprising a colored particle and other particles such as an external additive, a carrier or the like as needed; transferring the toner to a recording medium such as paper, an OHP sheet or the like; and fixing the transferred toner on the recording medium. Various kinds of methods has been conventionally proposed as a developing method with the use of a toner or fixing method of a printed image of a toner and in each of the image forming processes a suitable method is employed.

Generally, by agitating a toner for developing an electrostatic latent image in a developing system of electrostatic latent image, frictional electrification is imparted between toner particles comprising a colored particle and an external additive attached to the colored particle or between a toner particle and a carrier. Thereafter, the toner is supplied onto a photosensitive member having an electrostatic latent image and attached.

The moderately charged toner is attached on the photosensitive member in an amount corresponding to the charge density of the electrostatic latent image so as to form a fine image with desired tones.

In contrast, when the charge amount or charge distribution of a toner is inappropriate, problems may occur. For example, the developing amount of toner is too small so that insufficient image density or uneven image density may be observed, or a toner is developed in the area on a photosensitive member where a toner is not intended to be developed, resulting in occurrence of problems such as a fog which contaminates a body color of a printed product.

Particularly, when printing is performed consuming a large amount of toner in a short time (e.g. high-speed mass printing or continuous solid pattern printing) or in the early stage of printing just after starting operation of a developing system of an electrostatic latent image or just after charging a new toner into a developing system of an electrostatic latent image, there may be a case that the friction charge rate of the toner cannot follow the consumption rate of the toner so that problems of poor developing as mentioned above due to the insufficient charge amount or uneven charge distribution of the toner (e.g. insufficient or uneven image density, a fog and so on) are likely to occur.

Japanese Patent Application Laid-Open (JP-A) No. Hei. 6-11898 discloses that the color reproducibility of a full-color image is improved by considering the balance of the charge properties of magenta, cyan, yellow and black toners and adjusting the difference of work functions of the toners to 0.5 eV or less. However, JP-A No. Hei. 6-11898 does not take account of a method for solving problems such as insufficient image density, uneven image density, a fog and so on which occur when the consumption rate of toner is high or in the early stage of printing.

### DISCLOSURE OF INVENTION

An object of the present invention is to provide a toner for developing an electrostatic latent image which is capable of obtaining sufficient image density and preventing developing failure even in the state that a toner is likely to be deficient in charge amount or uneven in charge distribution such as when the consumption rate of toner is high or in the early stage of printing, and an image forming method using the toner for developing an electrostatic latent image.

As the result of diligent researches made to attain the above object, the inventors of the present invention obtained a knowledge that a toner of which work function is a value in a certain range and that a certain relation is established between the work function and a gradient of a normalized photoelectron yield of the toner can attain the above object.

The present invention is based on the above knowledge and provides a toner for developing an electrostatic latent image comprising a colored particle containing a colorant and a binder resin, wherein a work function X (eV) of the toner obtained in measuring work function and a gradient A (1/eV) of a normalized photoelectron yield with respect to an excitation energy calculated from a formula “normalized photoelectron yield/excitation energy” are in the ranges of 5.35<X<5.60 and A−55X+290>0.

As the colorant contained in the toner for developing an electrostatic latent image of the present invention, there may be a cyan colorant.

An average circularity of the toner for developing an electrostatic latent image of the present invention is preferably from 0.950 to 0.995.

pH of a water extract of the toner for developing an electrostatic latent image of the present invention is preferably in the range from 4 to 8.

It is preferable that the colored particle of the toner for developing an electrostatic latent image of the present invention contains a charge control agent and the charge control agent is a charge control resin.

Further, the present invention provides an image forming method comprising steps of:

a charging process to charge a photosensitive dram by a charging member;

an exposing process to form an electrostatic latent image on the photosensitive dram;

a developing process to develop the electrostatic latent image with a toner for developing an electrostatic latent image;

a transferring process to transfer the developed image on a recording medium; and

a fixing process to fix the transferred image on the recording medium,

wherein the toner for developing an electrostatic latent image comprises a colored particle containing a colorant and a binder resin, and a work function X (eV) of the toner in measuring work function and a gradient A (1/eV) of a normalized photoelectron yield with respect to an excitation energy calculated from a formula “normalized photoelectron yield/excitation energy” are in the ranges of 5.35<X<5.60 and A−55X+290>0.

When the work function X (eV) of a toner for developing an electrostatic latent image in measuring work function is a value in the range of 5.35<X<5.60 and further a relation of A−55X+290>0 is established between a work function X (eV) of the toner and a gradient A (1/eV) of a normalized photoelectron yield with respect to an excitation energy calculated from a formula “normalized photoelectron yield/excitation energy,” an initial charge speed of the toner is fast and a sufficient charge amount is obtained.

Accordingly, by developing an electrostatic latent image by means of a toner of the present invention, it is able to stably form a printing having a sharp and fine image with substantial image density and no background soiling (a fog) irrespective of printing environments and conditions.

Further, by an image forming method of the present invention with the use of the above-mentioned toner, it is able to stably form a printing having a sharp and fine image with substantial image density and no background soiling (a fog) irrespective of printing environments and conditions.

### BRIEF DESCRIPTION OF THE DRAWINGS

In the accompanying drawing,

FIG. 1 is a view showing a constitutional example of an image forming device to which a toner for developing an electrostatic latent image of the present invention is applied.

FIG. 2 is a view showing a general trend of a graph to measure work function of a toner with an excitation energy (eV) on the horizontal axis and a normalized photoelectron yield on the vertical axis.

The numerical symbol in each figure refers to the following: 1: a photosensitive dram; 5: a charging roller; 7: a laser light radiation device; 9: a transfer roller; 11: a recording medium; 13: a developing roller; 15: a blade for the developing roller; 17: a supply roller; 18: a stirring vane; 19: a toner; 21: a development apparatus; 23: a casing; 23a: a toner vessel; 25: a cleaning blade; 27: a fixing device; 27a: a heating roller; and 27b: a support roller.

### BEST MODE FOR CARRYING OUT THE INVENTION

Hereinafter, a toner for developing an electrostatic latent image of the present invention will be described.

A toner for developing an electrostatic latent image of the present invention comprises a colored particle containing a colorant and a binder resin, wherein a work function X (eV) of the toner obtained in measuring work function and a gradient A (1/eV) of a normalized photoelectron yield with respect to an excitation energy calculated from a formula “normalized photoelectron yield/excitation energy” are in the ranges of 5.35<X<5.60 and A−55X+290>0.

The work function represents an energy level of a substance-specific electron. In the present invention, the work function X (eV) of the toner obtained in measuring work function represents an energy level of a threshold that a toner starts to release an electron. The work function is known as an important quantity relating to the contact potential difference on the surface of a solid, electron emission, chemical activity and so on.

The normalized photoelectron yield denotes a photoelectron yield per unit photon raised to the 0.5 power. The gradient A (1/eV) of the normalized photoelectron yield with respect to the excitation energy calculated from a formula “normalized photoelectron yield/excitation energy” denotes a gradient shown in a graph with the excitation energy (eV) on the horizontal axis and the normalized photoelectron yield on the vertical axis.

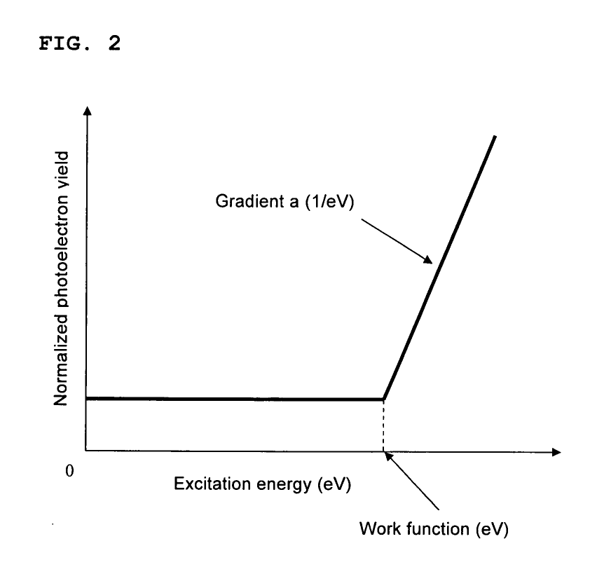

FIG. 2 is a view showing a general trend of a graph to measure the work function of a toner with the excitation energy (eV) on the horizontal axis and the normalized photoelectron yield on the vertical axis. This graph shows that in the region where the excitation energy is low, a flat base region with no change in the normalized photoelectron yield appears on the graph and when the excitation energy reaches a certain level, the normalized photoelectron yield starts to increase rapidly. The excitation energy of this change-point is the work function X (eV) of the toner subject to measurement.

Also, the gradient of the region where the excitation energy exceeds the work function X (eV) and the rate of change of the graph is stable is the gradient A (1/eV) of the normalized photoelectron yield with respect to the excitation energy. Consequently, the value of the gradient A is not affected by the flat base region where the excitation energy is low and there is no change in the normalized photoelectron yield.

There is no particular limitation on a method for measuring the work function X of a toner. In examples of the present specification, measurement is performed by means of a photoelectron spectrometer (product name: AC-2; manufactured by: Riken Keiki Co., Ltd.).

Specifically, first, a toner of about 0.5 g is provided on a measuring holder in an evenly spread manner. Next, irradiation is performed using a D₂ (deuterium) light source at 500 nW as a UV light source while scanning the energy of monochromatic incident light (with a spot size of 2 to 4 mm) every 0.1 (eV) from 3.4 (eV) to 6.2 (eV) to obtain normalized photoelectron yields with respect to excitation energy.

From measured value thus obtained, the work function X of the toner and the gradient A of the normalized photoelectron yield with respect to the excitation energy are determined by the following method. Firstly, the measured values obtained above are plotted on a graph with the excitation energy on the horizontal axis and the normalized photoelectron yield on the vertical axis. Next, from a flat base region which continues until just before the plotted normalized photoelectron yields show an increase on the graph, an appropriate number of measuring points are picked up. The normalized photoelectron yields of the measuring points are averaged and thus regarded as a baseline. More particularly, 11 normalized photoelectron yields found every 0.1 (eV) in the range from 4.2 (eV) to 5.2 (eV) of the excitation energy are averaged and regarded as a baseline. Next, when a continuous rise is observed in four normalized photoelectron yields found every 0.1 (eV) in the range from the baseline to 0.3 (eV), a value which is 0.2 (eV) larger than the excitation energy at the point where the normalized photoelectron yield starts to rise (a first point having the smallest excitation energy among the above four excitation energies) is regarded as a point where the rate of change of the graph (the gradient) begins to stabilize. Then, in the range from the value which is 0.2 (eV) larger than the excitation energy at the point where the normalized photoelectron yield starts to rise (a first point among the above four excitation energies) to 6.2 (eV), a primary line is obtained and the gradient of the primary line is determined as the gradient A (1/eV) of the normalized photoelectron yield with respect to the excitation energy. Further, the excitation energy of the intersection of the primary line and the baseline is determined as the work function X (eV).

When the work function X (eV) of the toner in measuring work function is in the range of 5.35<X<5.60 and a relation of A−55X+290>0 is established between the work function X (eV) of the toner and the gradient A (1/eV) of the normalized photoelectron yield with respect to the excitation energy calculated from a formula “normalized photoelectron yield/excitation energy,” an initial charge speed of the toner is fast and a sufficient charge amount is obtained. Herein, a fast initial charge speed means that when charging the toner, it takes a shorter time to reach the sufficient charge amount to develop an electrostatic latent image.

Accordingly, by developing an electrostatic latent image with the toner of the present invention, it is able to form a sharp and fine image with substantial image density and no background soiling (a fog) irrespective of printing environments and conditions.

Particularly, the toner of the present invention can stably and evenly provide a sufficient charge amount even in the state that the charge amount of a toner is likely to be insufficient, such as printing when performed consuming a large amount of toner in a short time (e.g. high-speed bulk printing or continuous solid pattern printing), or the early stage of printing just after starting operation of a developing system of an electrostatic latent image or just after supplying a new toner to a toner supplying member in a developing system of an electrostatic latent image. Consequently, a desired fine image can be obtained without occurrence of problems such as insufficient printing density, uneven image density, fogs and so on.

A toner for developing an electrostatic latent image of the present invention contains a colored particle and may contain other particles or components as needed such as an external additive which attaches on the surface of the colored particle, a carrier which is a particle to support the colored particle or the like.

A colored particle in the toner contains at least a colorant and a binder resin, and may contain other components as needed such as a charge control agent, a release agent or the like.

As the colorant, all kinds of pigments and dyes can be used including carbon black, titan black, a magnetic powder, oil black and titan white. A carbon black with a primary particle diameter of 20 to 40 nm is suitably used since a carbon black of which particle diameter is in this range can be uniformly dispersed in a toner and generation of a fog decreases.

To obtain a full-color toner, a yellow colorant, a magenta colorant and a cyan colorant are generally used.

As the yellow colorant, for example, a compound such as an azo based pigment, a condensed polycyclic based pigment or the like can be used. Specifically, there may be C. I. Pigment Yellow 3, 12, 13, 14, 15, 17, 62, 65, 73, 74, 75, 83, 90, 93, 97, 120, 138, 155, 180, 181, 185, 186 or the like.

As the magenta colorant, for example, a compound such as an azo based pigment, a condensed polycyclic based pigment or the like can be used. Specifically, there may be C. I. Pigment Red 31, 48, 57, 58, 60, 63, 64, 68, 81, 83, 87, 88, 89, 90, 112, 114, 122, 123, 144, 146, 149, 150, 163, 170, 184, 185, 187, 202, 206, 207, 209 or 251, C. I. Pigment Violet 19 or the like.

As the cyan colorant, for example, a phthalocyanine compound such as a copper phthalocyanine compound or the like and the derivative thereof, an anthraquinone compound or the like can be used. Specifically, there may be C. I. Pigment Blue 2, 3, 6, 15, 15:1, 15:2, 15:3, 15:4, 16, 17, 60 or the like. Among them, the phthalocyanine compound is preferable.

The amount of the colorant is preferably from 1 to 10 parts by weight with respect to a binder resin of 100 parts by weight.

In the present invention, particularly by using a cyan colorant such as a phthalocyanine compound or a derivative thereof, a cyan toner with a fast initial charge speed wherein the cyan toner has the work function X in the above-mentioned range and there is the above-mentioned relation between the work function X and the gradient A of the normalized photoelectron yield is obtained and suitably used.

As the binder resin contained in the colored particle, resins conventionally used as a binder resin of a toner can be used. For example, there may be a polymer of styrene or substitution derivatives thereof such as polystyrene, polyvinyl toluene or the like; a styrene copolymer such as a styrene-methyl acrylate copolymer, a styrene-ethyl acrylate copolymer, a styrene-butyl acrylate copolymer, a styrene-2-ethylhexyl acrylate copolymer, a styrene-methyl methacrylate copolymer, a styrene-ethyl methacrylate copolymer, a styrene-butyl methacrylate copolymer, a styrene-butadiene copolymer or the like; polymethyl methacrylate, polyester, an epoxy resin, polyvinyl butyral, an aliphatic or alicyclic hydrocarbon resin, polyolefin, a methacrylate resin, an acrylate resin, a norbornene resin, a hydrogenated product of the above-mentioned styrene based resin, or the like.

The colored particle preferably contains a charge control agent. As the charge control agent, charge control agents which are conventionally used for the toner can be used without limitation. Among charge control agents, a charge control resin (CCR) may be preferably used. A charge control resin has high compatibility with a binder resin and no color so as to obtain a toner having stable charge properties during high-speed continuous color printing.

As the charge control resin, there may be a resin which has a substituent selected from the group consisting of a carboxyl group or a group of the salt thereof, a group of phenols or a group of the salt thereof, a thiophenol group or a group of the salt thereof and a sulfonic acid group or a group of the salt thereof in a polymer side chain, or the like.

Among them, a resin having a sulfonic acid group or a group of the salt thereof in a polymer side chain may be preferably used. Specifically, there may be a resin obtained by copolymerization of a monovinyl monomer containing a sulfonic acid group or a group of the salt thereof with the other monovinyl monomer copolymerizable therewith. As the other copolymerizable monovinyl monomer, monovinyl monomers described below can be used.

As the monovinyl monomer containing a sulfonic acid group or a group of the salt thereof, for example, there may be styrenesulfonate, sodium styrenesulfonate, potassium styrenesulfonate, 2-acrylamido-2-methylpropanesulfonate, sodium vinyl sulfonate, ammonium methacryl sulfonate or the like.

A compounding amount of the monovinyl monomer containing a sulfonic acid group or a group of the salt thereof is preferably from 0.5 to 15 wt %, more preferably from 1 to 10 wt % of the charge control resin having a negatively charging ability. If the compounding amount of the monovinyl monomer containing a sulfonic acid group or a group of the salt thereof is less than the above range, the charge amount of a toner may decrease and pigment dispersion in a colored particle becomes insufficient so that image density and transparency may be reduced. If the compounding amount exceeds the above range, a decrease in charge amount of a toner at high temperature and humidity enlarges so that a fog may be generated.

As the charge control resin, a charge control resin with a weight average molecular weight of 2,000 to 50,000 may be preferable, more preferably from 4,000 to 40,000, and most preferably from 6,000 to 35,000. If the weight average molecular weight of a charge control resin is less than the above range, in the production of toner, viscosity may be excessively reduced upon mixing and kneading so that colorant dispersion may be insufficient. If the weight average molecular weight of a charge control resin exceeds the above range, fixing ability may lower.

The glass transition temperature of a charge control resin is preferably from 40 to 80° C., more preferably from 45 to 75° C., and most preferably from 45 to 70° C. If the glass transition temperature is less than the above range, shelf stability of a toner may decrease. If the glass transition temperature exceeds the above range, fixing ability may lower.

The use amount of the charge control resin is preferably from 0.01 to 30 parts by weight, more preferably from 0.3 to 25 parts by weight with respect to 100 parts by weight of a monovinyl monomer to be used for obtaining a binder resin.

In the present invention, the colored particle may preferably contain a release agent in addition. As a release agent, for example, there may be a low-molecular-weight polyolefin wax such as low-molecular-weight polyethylene, low-molecular-weight polypropylene, low-molecular-weight polybutylene or the like; a natural wax such as candelilla, a carnauba wax, a rice wax, a haze wax, jojoba or the like; a petroleum wax such as paraffin, microcrystalline, petrolatum or the like, and a modified wax thereof; a synthesized wax such as a Fischer-Tropsch wax or the like; a multifunctional esterified compound such as pentaerythritol tetramyristate, pentaerythritol tetrapalmitate, dipentaerythritol hexamyristate or the like; and so on.

The release agent may be used alone or in combination with two or more kinds.

Among the above-mentioned release agents, the synthesized wax and the multifunctional esterified compound are preferable. Among them, in DSC curve measured by means of a Differential Scanning Calorimetry, a multifunctional esterified compound, wherein the endothermic peak temperature is in the range from preferably 30 to 150° C., more preferably 40 to 100° C., and most preferably 50 to 80° C. in temperature rising, is preferable since a toner which is excellent in fixing-peeling balance upon fixing can be obtained. Particularly, a multifunctional esterified compound of which molecular weight is 1,000 or more, of which 5 parts by weight or more with respect to styrene of 100 parts by weight dissolves at 25° C., and of which acid value is 10 mg KOH/g or below is further preferable since it is remarkably effective in reducing the fixing temperature. The endothermic peak temperature is a value measured in accordance with ASTM D3418-82.

The amount of the release agent is generally from 0.5 to 50 parts by weight and preferably from 1 to 20 parts by weight with respect to 100 parts by weight of a monovinyl monomer.

The colored particle may be a so-called core-shell type particle, which can be obtained by using two different polymers, one for the inside of the particle (a core layer) and another for the outside of the particle (a shell layer), in combination. The core-shell type particle is preferable since it is able to balance lowering a minimum fixing temperature (fixing ability) and prevention of toner aggregation during storage (shelf stability) by covering a substance having a low softening point inside (a core layer) with a substance having a higher softening point than the core layer.

The core layer of the core-shell type particle generally comprises the binder resin, the colorant, and as required, the charge control resin and the release agent. On the other hand, the shell layer generally comprises the binder resin only. It may further contain the colorant.

In the case of a core-shell type particle, the glass transition temperature of a polymer constituting the core layer is preferably from 0 to 80° C. and more preferably from 40 to 60° C. If the glass transition temperature exceeds the above range, the minimum fixing temperature may increase. On the other hand, if the glass transition temperature is less than the above range, shelf stability may decrease.

Further, the glass transition temperature of a polymer constituting the shell layer is required to be higher than that of the polymer constituting the core layer. To improve shelf stability of a toner, the glass transition temperature of a polymer constituting a shell layer is preferably from 50 to 130° C., more preferably from 60 to 120° C., and most preferably from 80 to 110° C. If the glass transition temperature is less than the above range, shelf stability may decrease. On the other hand, if the glass transition temperature exceeds the above range, the minimum fixing temperature may increase (or fixing ability may decrease).

The difference of the glass transition temperatures of the polymer constituting a core layer and the polymer constituting a shell layer may be preferably 10° C. or more, more preferably 20° C. or more, and most preferably 30° C. or more. If the difference is less than the range, a balance between shelf stability and fixing ability may deteriorate.

The weight ratio of the core layer and the shell layer of the core-shell type particle is not specifically limited, however, a preferable weight ratio of the core layer and the shell layer is from 80:20 to 99.9:0.1.

If the ratio of a shell layer is less than the above ratio, shelf stability may decrease. If the ratio of a shell layer is more than the ratio, fixing ability may decrease in contrast.

In the present invention, the volume average particle diameter “Dv” of a colored particle and a toner may be preferably from 3 to 10 μm, more preferably from 4 to 8 μm. If “Dv” is less than the above range, toner flowability decreases so that a fog or remaining toner may occur or toner cleanability may be reduced. If “Dv” is more than the above range, thin line reproducibility may decrease.

The ratio “Dv/Dp” of the volume average particle diameter “Dv” and the number average particle diameter “Dp” of a colored particle and a toner is generally from 1.0 to 1.3, preferably from 1.0 to 1.2. If the ratio “Dv/Dp” exceeds the above range, transferability may decrease or a fog may occur.

The average circularity of a toner of the present invention is preferably from 0.95 to 0.995, more preferably from 0.95 to 0.99, most preferably from 0.96 to 0.99. If an average circularity is less than the above range, thin line reproducibility decreases in any of L/L environment (temperature: 10° C.; relative humidity: 20%), N/N environment (temperature: 23° C.; relative humidity: 50%) and H/H environment (temperature: 35° C.; relative humidity: 80%).

It is relatively easy to keep the average circularity within the above range by using the phase inversion emulsion method, the solution suspension method, the polymerization method and so on.

In the present invention, the circularity is a value obtained by dividing a perimeter of a circle having the same area as a projected image of a particle by a perimeter of the projected image of the particle. Also, the average circularity of the present invention is used as a simple method of presenting a shape of a particle quantitatively and is an indicator showing the level of convexo-concave shapes of the toner. The average circularity is “1” when the toner is an absolute sphere, and becomes smaller as the shape of the surface of the toner becomes more complex. In order to obtain the average circularity “Ca”, firstly, circularity “Ci” of each of measured “n” particles having 1 μm or more diameter of the equivalent circle is calculated by the following formula:

circularity “Ci”=a perimeter of a circle having the same area as a projected area of a particle/a perimeter of the projected image of the particle.

Next, the average circularity “Ca” is obtained by the following formula:

$$average circularity = ( {\sum }_{i = 1}^{n} ( Ci \times fi ) ) / {\sum }_{i = 1}^{n} ( fi )$$

In the above formula, “fi” is the frequency of a particle of the circularity “Ci”.

The above circularity and average circularity are measured by means of a flow particle image analyzer (product name: FPIA-1000 or FPIA-2000; manufactured by Sysmex Co.).

The colored particle of the toner of the present invention may be directly used as a toner for developing an electrostatic latent image. Further, in order to control charge property, flowability, shelf stability and so on of a toner, a high-speed agitator such as HENSCHEL MIXER (product name) or the like is used when mixing a colored particle, an external additive, and if required, other particles to form a one-component toner.

Further, a carrier particle such as ferrite, iron powder or the like may be added to the colored particle, the external additive, and if required, other particles and be mixed by various known methods to form a two-component toner.

As the external additive, there may be generally an inorganic fine particle and an organic fine particle conventionally used for a toner in order to improve fluidity and charge property. For example, as the inorganic fine particle, there may be silica, aluminum oxide, titanium oxide, zinc oxide, tin oxide, calcium carbonate, calcium phosphate, cerium oxide or the like. As the organic fine particle, there may be a methacrylate polymer, an acrylate polymer, a styrene-methacrylate copolymer, a styrene-acrylate copolymer, a melamine resin, a core-shell type particle of which core layer is made of a styrene polymer and shell layer is made of a methacrylate polymer, or the like. Among them, silica and titanium oxide may be preferable, a particle of silica or titanium oxide of which surface is subject to a hydrophobicity-imparting treatment may be more preferable, silica which is subject to a hydrophobicity-imparting treatment may be still further preferable. Simultaneously using two or more kinds of silica which are subject to hydrophobicity-imparting treatment is particularly preferable. An added amount of the external additive may be generally from 0.1 to 6 parts by weight with respect to a colored particle of 100 parts by weight.

The colored particle can be produced by conventionally known methods such as the pulverization method, the polymerization method, the association method or the phase inversion emulsion method or the like.

Particularly in the case of producing a core-shell type particle, a colored particle produced as a core layer by one of the above methods is covered with a shell layer by a conventionally known method such as the spray dry method, the interface reaction method, the in situ polymerization method, the phase separation method or the like so that a core-shell type colored particle is obtained.

Among the production methods, the polymerization method is preferable for obtaining a colored particle with an average circularity of 1, that is, a colored particle which is nearly an absolute sphere. To produce a core-shell type colored particle, it is preferable to cover a colored particle produced by the polymerization method with a shell layer by the in situ polymerization method.

Hereinafter, a method for producing a colored particle to be a core layer and covering the colored particle with a shell layer by the in situ polymerization method will be described.

Firstly, a colored particle to be a core layer can be produced by steps of: dissolving or dispersing a colorant, and if necessary, a charge control agent and other additives in a polymerizable monomer, which is a material of a binder resin, to form a polymerizable monomer compound; forming droplets of the polymerizable monomer compound in an aqueous dispersion medium containing a dispersion stabilizer; and adding a polymerization initiator to polymerize the droplets, and if required, agglomerating particles each other, followed by filtering, washing, dewatering and drying.

As the polymerizable monomer, there may be a monovinyl monomer, a crosslinkable monomer, a macromonomer, other monomers or the like. The polymerizable monomers are subject to polymerization so as to be a binder resin component in a colored particle.

As the monovinyl monomer, for example, there may be an aromatic vinyl monomer such as styrene, vinyl toluene, α-methyl styrene or the like; a (meth)acrylic acid monomer such as (meth)acrylic acid, methyl (meth)acrylate, ethyl (meth)acrylate, propyl (meth)acrylate, butyl (meth)acrylate, 2-ethylhexyl (meth)acrylate, cyclohexyl (meth)acrylate, isobornyl (meth)acrylate, dimethyl aminoethyl (meth)acrylate, (meth)acrylamide or the like; a monoolefin polymer such as ethylene, propylene, butylene or the like; and so on.

The above-mentioned monovinyl monomers may be used alone or in combination of two or more kinds. Among the monovinyl monomers, an aromatic vinyl monomer alone or a combination of an aromatic vinyl monomer and a (meth)acrylic acid monomer is suitably used. “(Meth)acrylic acid” refers to “acrylic acid” or “methacrylic acid”.

A crosslinkable monomer is effective to improve hot offset when used with the monovinyl monomer.

Herein, the crosslinkable monomer is a monomer having two or more polymerizable carbon-carbon unsaturated double bonds. As such a monomer, for example, there may be an aromatic divinyl compound such as divinyl benzene, divinyl naphthalene, a derivative thereof or the like; a diethylenically unsaturated carboxylic acid ester such as ethylene glycol dimethacrylate, diethylene glycol dimethacrylate or the like, and a compound having two vinyl groups in a molecule such as divinyl ether or the like; a compound having three or more vinyl groups in a molecule such as pentaerythritol triallyl ether, trimethylolpropane triacrylate or the like; and so on.

The crosslinkable monomers may be used alone or in combination of two or more kinds. The use amount is generally 10 parts by weight or less, preferably from 0.1 to 2 parts by weight with respect to a monovinyl monomer of 100 parts by weight.

In the present invention, a macromonomer may be used as a part of the polymerizable monomer. It is preferable to use the macromonomer since shelf stability and fixing ability are well-balanced. The macromonomer is an oligomer or a polymer which has a vinyl polymerizable functional group at the end of a polymer chain and has a number average molecular weight preferably from 1,000 to 30,000. When using a macromonomer with a number average molecular weight of less than 1,000, the surface portion of a toner softens so that shelf stability may decrease. On the other hand, when using a macromonomer with a number average molecular weight exceeding 30,000, meltability of the macromonomer is reduced so that shelf stability and fixing ability may decrease. Herein, as the vinyl polymerizable functional group, there may be an acryloyl group, a methacryloyl group or the like. For easiness of copolymerization, a methacryloyl group is preferred.

As the macromonomer, it is preferable to use a macromonomer which provides a polymer with higher Tg than that of a polymer obtained by polymerization of the monovinyl monomer.

As a specific example of the macromonomer used in the present invention, there may be a macromonomer comprising a polymer obtained by polymerization of styrene, a styrene derivative, methacrylic ester, acrylic ester or the like, or the combination thereof; and so on. Among them, one with hydrophilicity, particularly a polymer obtained by polymerization of methacrylic ester or acrylic ester alone or the combination thereof may be preferably used.

When using the macromonomer simultaneously, the use amount is generally from 0.01 to 10 parts by weight, preferably from 0.03 to 5 parts by weight, more preferably from 0.05 to 1 part by weight with respect to 100 parts by weight of a monovinyl monomer. If the use amount of the macromonomer is less than the above range, shelf stability of a toner may be reduced. If the use amount of the macromonomer exceeds the above range, fixing ability may decrease.

As the other monomer, a radically polymerizable epoxy compound or a radically polymerizable acid halide compound may be contained to improve colorant dispersibility and to prevent reaggregation.

As the radically polymerizable epoxy compound, for example, there may be glycidyl methacrylate, glycidyl acrylate, allyl glycidyl ether, styryl glycidyl ether, an epoxy resin and so on.

As the radically polymerizable acid halide, for example, a chloride compound such as acrylic chloride, methacrylic chloride, styrene carbonyl chloride, styrene sulfonyl chloride, 2-methacryloyloxy ethyl succinyl chloride, 2-methacryloyloxy ethyl hexahydrophthalyl chloride or the like; a bromide compound such as acrylic bromide, methacrylic bromide, styrene carbonyl bromide, styrene sulfonyl bromide, 2-methacryloyloxy ethyl succinyl bromide, 2-methacryloyloxy ethyl hexahydrophthalyl bromide or the like; and so on.

When using the radically polymerizable epoxy compound or acid halide compound, a compounding amount is preferably from 0.1 to 5 parts by weight, more preferably from 0.2 to 3 parts by weight in a polymerizable monomer used to provide a binder resin component. If the compounding amount of the radically polymerizable epoxy compound or acid halide compound is less than the above range, the dispersion effect of a colorant becomes insufficient. It the compounding amount exceeds the above range, reduction in image quality such as generation of hot offset may occur.

The radically polymerizable epoxy compound or halide compound may be used alone or in combination with two or more kinds.

In the present invention, a charge control resin composition obtained by preliminarily mixing the colorant and the charge control resin as the charge control agent may be mixed with other compounding components to prepare a polymerizable monomer composition. Thereafter, a droplet of the polymerizable monomer composition may be formed and polymerized in an aqueous dispersion medium. A compounding amount of the colorant mixed with the charge control resin may be generally from 10 to 200 parts by weight, preferably from 20 to 150 parts by weight, with respect to a charge control resin of 100 parts by weight. It is preferable to add a radically polymerizable epoxy compound such as glycidyl methacrylate (GMA) or the like or a radically polymerizable acid halide compound upon mixing the colorant and the charge control resin since the compound acts on the surface of the colorant to improve uniformity of colorant dispersion.

An organic solvent is preferably used for producing the charge control resin composition. With the use of the organic solvent, the charge control resin may be softened and can be easily mixed with a colorant.

An amount of the organic solvent is from 0 to 100 parts by weight, preferably from 5 to 80 parts by weight, more preferably from 10 to 60 parts by weight, with respect to 100 parts by weight of a charge control resin. When the amount is in this range, dispersibility and workability can be well-balanced. The organic solvent may be added at once or in several batches carefully watching the mixing state.

Mixing can be performed by means of a roller, a kneader, a single screw extruder, a twin screw extruder, a banbury mixer, a Buss cokneader (manufactured by: Buss Co.) or the like. When using the organic solvent, a sealed mixer from which no organic solvent leaks is preferable for problems of toxicity and odor.

Further, a mixer is preferably provided with a torquemeter so that dispersibility can be controlled in torque.

As the dispersion stabilizer, a conventionally known surfactant, an inorganic dispersing agent or an organic dispersing agent may be used. Among them, the inorganic dispersing agent is preferable since it is easily removed in post-processing. As the inorganic dispersing agent, for example, there may be an inorganic salt such as barium sulfate, calcium carbonate, calcium phosphate or the like; an inorganic oxide such as silica, aluminum oxide, titanium oxide or the like; an inorganic hydroxide such as aluminum hydroxide, magnesium hydroxide, ferric hydroxide or the like; and so on. Among them, a dispersion stabilizer containing hardly water-soluble inorganic hydroxide colloid is particularly preferable since it can narrow the particle size distribution of a polymer particle and is less likely to remain after washing so that a sharp image can be reproduced.

The dispersion stabilizer is generally used at an amount in the range from 0.1 to 20 parts by weight with respect to a polymerizable monomer of 100 parts by weight. The use amount is preferable to be in the range since sufficient polymerization stability is obtained and generation of polymerization flocculant product is prevented so as to obtain a toner with a desired particle diameter.

As the polymerization initiator, for example, there may be a persulfate such as potassium persulfate, ammonium persulfate or the like; an azo compound such as 4,4′-azobis(4-cyanovaleric acid), 2,2′-azobis(2-methyl-N-(2-hydroxyethyl)propionamide), 2,2′-azobis(2-amidinopropane) dihydrochloride, 2,2′-azobis(2,4-dimethylvaleronitrile), dimethyl-2,2′-azobis(2-methyl propionate), 2,2′-azobisisobutyronitrile or the like; organic peroxide such as di-t-butyl peroxide, dicumyl peroxide, lauroyl peroxide, benzoyl peroxide, t-butylperoxy-2-ethylhexanoate, t-hexylperoxy-2-ethylhexanoate, t-butylperoxy pivalate, di-isopropyl peroxydicarbonate, di-t-butylperoxy isophthalate, 1,1,3,3-tetramethylbutylperoxy-2-ethylhexanoate, t-butylperoxy isobutylate or the like; and so on. Also, there may be a redox initiator, which is a combination of the polymerization initiator and a reducing agent.

Among the polymerization initiators, an oil-soluble polymerization initiator which is soluble in a polymerizable monomer to be used is preferably selected and may be simultaneously used with a water-soluble polymerization initiator as needed. The polymerization initiator may be used at an amount in the range from 0.1 to 20 parts by weight, preferably 0.3 to 15 parts by weight, more preferably 0.5 to 10 parts by weight, with respect to 100 parts by weight of a polymerizable monomer.

The polymerization initiator may be preliminarily added in the polymerizable monomer composition. In the case of suspension polymerization, the polymerization initiator may be directly added to a suspension after completion of a forming process of droplets of the polymerizable monomer composition. In the case of emulsion polymerization, the polymerization initiator may be directly added to an emulsified liquid after completion of an emulsifying process.

Further, upon polymerization, a molecular weight modifier may be preferably added to a reaction system. As the molecular weight modifier, for example, there may be mercaptans such as t-dodecyl mercaptan, n-dodecyl mercaptan, n-octyl mercaptan, 2,2,4,6,6-pentamethylheptane-4-thiol or the like; thiuram disulfides such as tetramethylthiuram disulfide, tetraethylthiuram disulfide or the like; and so on. The molecular weight modifiers can be added before or during polymerization. The molecular weight modifier may be added at an amount generally in the range from 0.01 to 10 parts by weight, preferably 0.1 to 5 parts by weight, with respect to a polymerizable monomer of 100 parts by weight.

Next, to cover the colored particle produced by the above-mentioned polymerization method with a shell layer by the in situ polymerization method, in an aqueous dispersion medium in which a particle to be a core layer disperses, a polymerizable monomer to form a shell layer (a polymerizable monomer for shell) and a polymerization initiator are added to polymerize followed by filtering, washing, dewatering and drying so as to obtain a core-shell type colored particle.

As a specific method to form a shell layer, there may be adapted some methods, such as a method of continuous polymerization wherein a polymerizable monomer for shell is added to a reaction system of a polymerization reaction performed for obtaining a particle to be a core layer; a method of polymerization in stages that a particle to be a core layer is prepared by adding a polymerizable monomer to a different reaction system and allowed to polymerize and associate followed by filtering, washing, dewatering and drying and to the core layer prepared, a polymerizable monomer for shell is added; and so on.

As the polymerizable monomer for shell, a monomer which provides a polymer having Tg of more than 80° C. such as styrene, acrylonitrile, methyl methacrylate or the like may be preferably used alone or in combination with two or more kinds.

As a water-soluble polymerization initiator, there may be persulfate such as potassium persulfate, ammonium persulfate or the like; an azo compound such as 2,2′-azobis(2-methyl-N-(2-hydroxyethyl)propionamide), 2,2′-azobis-(2-methyl-N-(1,1-bis(hydroxymethyl)-2-hydroxyethyl)propionamide) or the like; and so on. An amount of the water-soluble polymerization initiator is generally from 0.1 to 50 parts by weight, preferably from 1 to 30 parts by weight, with respect to a polymerizable monomer for shell of 100 parts by weight.

The work function X in measuring work function and the gradient A of the normalized photoelectron yield with respect to the excitation energy become liable to be in the preferable range in such a manner that a metal salt of phthalocyanine (for example, zinc phthalocyanine or the like) of 0.001 to 1 part by weight is dispersed in the above-mentioned polymerizable monomer for shell and the dispersion liquid thus obtained is added to an aqueous dispersion of particle to be a core layer for polymerization to form a shell layer containing a metal salt of phthalocyanine on the surface of the particle to be a core layer.

It is preferable that acid or alkali is added in an aqueous dispersion of a colored particle obtained by polymerization to dissolve a dispersion stabilizer in water for removal. When using a hardly water-soluble inorganic hydroxide colloid as a dispersion stabilizer, it is preferable to adjust the aqueous dispersion to be pH 6.5 or less by adding acid. As the acid to be added, there may be an inorganic acid such as sulfuric acid, hydrochloric acid, nitric acid or the like and an organic acid such as formic acid, acetic acid or the like. Sulfuric acid is particularly suitable for large removal efficiency and small adverse affect on production facilities.

There is no particular limitation on a method for filtering and dewatering a colored particle from an aqueous dispersion medium. For example, there may be centrifugal filtration, vacuum filtration, pressure filtration and so on. Among them, centrifugal filtration is suitable.

When a colored particle obtained by the above filtration method, preferably a core-shell type colored particle, is mixed with an external additive, a carrier or other microparticles as required, a high-speed agitator (product name: HENSCHEL MIXER) may be used.

In the above-mentioned production method of toner, it is preferable to take the following steps to obtain a toner for developing an electrostatic latent image, wherein the work function X (eV) of the toner obtained in measuring work function and the gradient A (1/eV) of the normalized photoelectron yield with respect to the excitation energy calculated from a formula “normalized photoelectron yield/excitation energy” are in the ranges of 5.35<X<5.60 and A−55X+290>0.

(1) As mentioned above, an appropriate amount of metal salt of phthalocyanine is dispersed in a polymerizable monomer for shell and then a dispersion liquid thus obtained is added to an aqueous dispersion of a particle to be a core layer for polymerization so as to form a shell layer containing a metal salt of phthalocyanine on the surface of a particle to be a core layer.

(2) As mentioned above, in a charge control resin compound preliminarily prepared by mixing a colorant with a charge control resin, a radically polymerizable epoxy compound, such as glycidyl methacrylate (GMA) or the like, or a radically polymerizable acid halide compound is contained.

(3) A colored particle is washed with water with low electrical conductivity.

pH of a water extract of the toner for developing an electrostatic latent image of the present invention is preferably from 4 to 8, more preferably from 5 to 7. It is possible to adjust pH of the water extract of the toner within the above range by properly performing acid washing and water washing of a colored particle (an intermediate product) in the production of toner.

When pH of the water extract is less than the above-mentioned range, environmental stability of a toner may be decreased. On the other hand, environmental stability may also be reduced when pH exceeds the above-mentioned range. pH of the water extract of the toner can be obtained in such a manner that 6 g of a toner dispersed in 100 g of ion-exchanged water at about pH 7 is boiled for ten minutes and then subject to measurement of pH.

Also, the chrominance ΔE of a filtrate obtained by filtering a toner dispersion comprising a toner of the present invention of 0.2 g dispersed in tetrahydrofuran of 100 ml with a filter with a pore size of 0.45 μm, is preferably 5 or more, further preferably 10 or more, with respect to tetrahydrofuran when measured with a spectrometer. If the chrominance ΔE is less than 5, pigment dispersion in the toner may be insufficient so that printing density after fixing may decrease.

In an electrophotography, an electrostatic recording method, an electrostatic printing process, a magnetic recording method or the like, the toner of the present invention may be widely used in a developing system of an electrostatic latent image, a developing method, an image forming device to develop a latent image with electrostatic properties such as an electrostatic latent image, a magnetic latent image or the like and to form an image such as a picture, a drawing, a character, a symbol or the like. Particularly, the toner of the present invention is suitably used in a system, a method or a device to supply toner for an electrostatic latent image on a photosensitive member after the toner is charged by a charging method that toner particles are or toner particles and carriers are brought into contact with each other by stirring the toner or by other appropriate charging methods.

Hereinafter, an image forming device to which a toner of the present invention is applied will be described in reference to drawings.

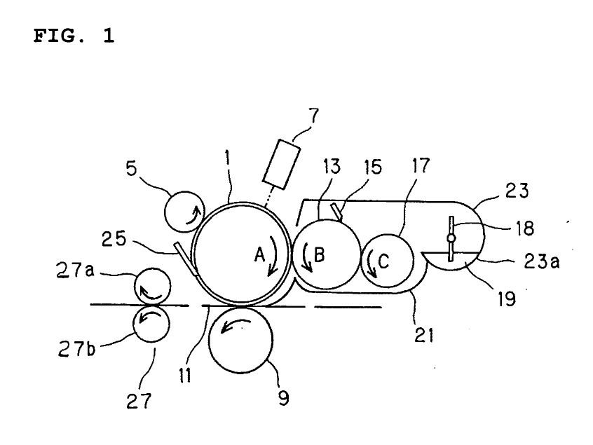

FIG. 1 shows an example of a constitution of an image forming device to which a toner for developing an electrostatic latent image of the present invention is applied. The image forming device shown in FIG. 1 has a photosensitive dram 1 as a photosensitive member. The photosensitive dram 1 is mounted so as to be able to rotate freely in the direction of an arrow “A”. A photoconductive layer is attached to a conductive support dram.

Around the photosensitive dram 1 along the circumferential direction thereof, a charging roller 5 as a charging member, a laser light radiation device 7 as exposure equipment, a development apparatus 21, a transfer roller 9 and a cleaning blade 25 are arranged.

Also, on the downstream side of the conveying direction of the photosensitive dram 1, a fixing device 27 is provided. The fixing device 27 comprises a heating roller 27a and a support roller 27b.

The conveying route of a recording medium 11 is provided so that the transferring material is conveyed between the photosensitive dram 1 and the transfer roller 9, and between the heating roller 27a and the support roller 27b.

An image is formed by means of such an image forming device as shown in FIG. 1, and the image forming method of the present invention is a method of forming an image comprising the processes of: a charging process in which a photosensitive dram is charged by means of a charging member; an exposing process in which an electrostatic latent image is formed on the photosensitive dram; a developing process in which the electrostatic latent image is developed with a toner for developing an electrostatic latent image; a transferring process in which a developed image is transferred onto a recording medium; and a fixing process in which a transferred image is fixed on the recording medium, and wherein, the toner for developing an electrostatic latent image is a toner for developing an electrostatic latent image comprising a colored particle comprising a colorant and a binder resin; wherein a work function X (eV) of the toner obtained in measuring work function and a gradient A (1/eV) of a normalized photoelectron yield with respect to an excitation energy calculated from a formula “normalized photoelectron yield/excitation energy” are in the ranges of 5.35<X<5.60 and A−55X+290>0.

Hereinafter, each process will be described in detail.

The charging process is a process to charge positively or negatively the surface of the photosensitive dram 1 uniformly. As the charging method with the use of the charging member, there may be the charging roller 5 shown in FIG. 1, and also a contact charging method, which uses a fur brush, a magnetic brush, a blade or the like to charge, and a non-contact charging method, which uses corona discharge. It is possible to replace the charging roller 5 by such a contact charging method or non-contact charging method.

The exposing process is a process to radiate light corresponding to image signal on the surface of the photosensitive dram 1 by means of the laser light radiation device 7 as an exposure device as shown in FIG. 1, and to form an electrostatic latent image on the surface of the photosensitive dram 1 charged uniformly. Such a laser light radiation device 7 comprises, for example, a laser radiation apparatus and an optical lens. As an exposure device, there may be a LED radiation apparatus besides the one shown in FIG. 1.

The developing process is a process to attach toner for development to the electrostatic latent image formed on the surface of the photosensitive dram 1 through the exposing process by means the development apparatus 21. In the case of reversal development, toner is attached only to a light radiated part. In the case of normal development, toner is attached only to a light non-radiated part.

The development apparatus 21 furnished in the image forming device shown in FIG. 1 is a development apparatus used for a one-component contact developing method, comprising a stirring vane 18, a developing roller 13 and a supply roller 17 in a casing 23 in which a toner 19 is stored.

The stirring vane 18 is furnished in a toner vessel 23a formed on the upper stream side of the toner supply direction of the casing 23. The toner 19 is agitated so as to uniform toner charging.

The developing roller 13 is disposed to partially contact the photosensitive dram 1, and rotates in the direction “B” opposite to the direction of the photosensitive dram 1. The supply roller 17 rotates in the direction “C” similarly to the direction of the developing roller 13 in contact with the developing roller 13. The toner 19 is supplied to the supply roller 17 at the toner vessel 23a and is attached to the outer periphery of the supply roller 17. Then, the supply roller 17 supplies the toner 19 to the outer periphery of the developing roller 13. As other developing methods, there may be a one-component non-contact developing method, a two-component contact developing method and a two-component non-contact developing method.

At a position of the outer periphery of the developing roller 13, between a contact point of the developing roller 13 with the supply roller 17 and a contact point of the developing roller 13 with the photosensitive dram 1, a blade 15 for the developing roller is arranged as a toner layer thickness controlling member. The blade 15 is made of, for example, a conductive rubber elastic body or metal.

The transferring process is a process to transfer an image of the toner formed on the surface of the photosensitive dram 1 by means of the development apparatus 21 to the recording medium 11 such as paper or the like. Generally, transfer to the recording medium 11 is performed by means of the transfer roller 9 as shown in FIG. 1. Further, there may be transferring methods such as a belt transfer, a corona transfer and so on.

Generally, the cleaning process follows after the transferring process. The cleaning process is a process to clean the toner remained on the surface of the photosensitive dram 1. In the image forming device shown in FIG. 1, the cleaning blade 25 is used. The cleaning blade 25 may be made of, for example, a rubber elastic body such as polyurethane, an acrylonitrile-butadiene copolymer or the like.

In the image forming device shown in FIG. 1, after the whole surface of the photosensitive dram 1 is negatively and uniformly charged by the charging roller 5, an electrostatic latent image is formed by means of the laser light radiation device 7. Further, an image of the toner is developed by means of the development apparatus 21. Next, the image of the toner on the photosensitive dram 1 is transferred to the recording medium 11 such as paper or the like by the transfer roller 9. Toner remained on the surface of the photosensitive dram 1 is cleaned by the cleaning blade 25. Thereafter, a new image forming cycle begins.

When the image forming device exemplified in FIG. 1 uses a toner for developing an electrostatic latent image of the present invention, the absolute value of the toner charge amount of a toner layer formed on the developing roller 13 is preferably in the range from 20 to 70 μC/g, more preferably from 20 to 60 μC/g. The toner charge amount of a toner layer formed on the developing roller 13 can be obtained by suctioning the toner layer on the developing roller 13 by means of a suction type Q/m analyzer and measuring the toner charge amount per unit weight from the charge amount and the weight of the toner suctioned.

The fixing process is a process to fix an image of the toner transferred to the recording medium 11. In the image forming device shown in FIG. 1, at least one of the heating roller 27a heated by a heating means (not shown) and the support roller 27b is rotated, and the recording medium 11 passes therethrough so as to be heated and pressed.

The image forming device shown in FIG. 1 is an image forming device for monochrome, however, a toner of the present invention can be applied to color image forming devices such as a copying machine, a printer and so on which are capable of forming a color image.

### EXAMPLES

Hereinafter, the present invention will be explained further in detail with reference to examples. However, the scope of the present invention may not be limited to the following examples. Herein, “part(s)” and “%” are based on weight if not particularly mentioned.

### <Testing Method>

Testing methods performed in the following examples are as follows.

### (1) Particle Diameter

The volume average particle diameter “Dv”, a particle size distribution, that is, a ratio “Dv/Dp” of the volume average particle diameter “Dv” and the number average particle diameter “Dp,” and a number-based percentage of a colored particle with a particle diameter of 4 μm or less were respectively measured by means of a particle diameter measuring device (product name: MULTISIZER; manufactured by: Beckman Coulter, Inc.). Measurement by means of Multisizer was carried out under the following condition: an aperture diameter of 100 μm; Isoton II as a medium; and a number of the measured particles of 100,000.

### (2) Average Circularity of Toner

In a container pre-filled with 10 ml of ion-exchanged water, 0.02 g of a surfactant (alkyl benzene sulfonate) was charged as a dispersing agent followed by a toner of 0.02 g and then subject to dispersion treatment by means of an ultrasonic disperser at 60 watts for three minutes. The colored particle density when measured was adjusted to be 3,000 to 10,000 particles/μL, and 1,000 to 10,000 colored particles of 1 μm or more by a diameter of the equivalent circle were subject to measurement by means of a flow particle image analyzer (product name: FPIA-1000; manufactured by: Sysmex Co.). The average circularity was calculated from measured values thus obtained.

Circularity can be calculated with the following formula and the average circularity is an average of the calculated circularities.

Circularity=a circumference of a circle having a projected area same as that of a particle image/a perimeter of a particle

### (3) pH of Water Extract

6 g of a toner dispersed in 100 g of ion-exchanged water, which was subject to cation exchange treatment and anion exchange treatment to be pH 7, was heated to be boiled and kept boiling for ten minutes to obtain a water extract. The water extract thus obtained was added with another ion-exchanged water, which was boiled for ten minutes and subject to cation exchange treatment and anion exchange treatment to be pH 7, so as to reach the initial volume before boiling and cooled down to a room temperature of about 25° C., followed by measurement of pH by means of a pH meter, thus obtained “pH of a water extract” of the toner.

### (4) Work Function X (eV)

The work function X of a toner was measured by means of a photoelectron spectrometer surface analyzer (product name: AC-2; manufactured by: Riken Keiki Co., Ltd.). Firstly, a toner of about 0.5 g was provided on a measuring holder in an evenly spread manner. Next, irradiation with a D₂ (deuterium) light source at 500 nW as a UV light source was performed while scanning with the energy of monochromatic incident light (with a spot size of 2 to 4 mm) every 0.1 (eV) from 3.4 (eV) to 6.2 (eV) to obtain normalized photoelectron yields with respect to excitation energy.

From measured normalized photoelectron yields thus obtained, a work function X of the toner and a gradient A of the normalized photoelectron yield with respect to the excitation energy were determined by the following method. Firstly, 11 normalized photoelectron yields found every 0.1 (eV) in the range from 4.2 (eV) to 5.2 (eV) of the excitation energy were averaged and regarded as a baseline. Next, when a continuous rise of normalized photoelectron yield was observed in the range from the baseline to 0.3 (eV) (four normalized photoelectron yields for every 0.1 (eV)), a primary line was obtained in the range from a value, which is 0.2 (eV) larger than the excitation energy of one of the four normalized photoelectron yields which started to rise first, to 6.2 (eV). A gradient of the primary line was determined as a gradient A (1/eV) of the normalized photoelectron yield with respect to the excitation energy. Further, an excitation energy of the intersection of the primary line and the baseline was determined as a work function X (eV).

### (5) Printing Test (Printing Density in N/N and H/H Environments)

A commercially available printer of a non-magnetic one-component developing method (printing speed: 18 prints per minute) was charged with a toner and left in N/N environment with a temperature of 23° C. and humidity of 50%. In the same environment, continuous printing was performed with the printing density of 5% at the beginning, and at the tenth page, solid pattern printing (with the printing density of 100%) was performed. By means of a McBeth transmitting image densitometer, the tenth page with solid pattern printing was measured for reflection density in the early stage of printing at the upper end, center and lower end of the solid pattern printed area. The average of measured values was regarded as N/N printing reflection density in the early stage of printing.

In a similar manner, the printer was charged with a toner and left for 20 hours in H/H environment with a temperature of 30° C. and humidity of 80% to measure H/H printing reflection density in the early stage of printing.

Further, printing reflection density in the upper end and the lower end of the solid pattern printed area of the solid pattern printing, which was subject to the measurement of N/N printing reflection density in the early stage of printing, was measured to calculate a decreasing rate of N/N printing reflection density in the early stage of printing by the following formula:

decreasing rate of printing reflection density (%)=[(printing reflection density at the upper end of the solid pattern printed area)−(printing reflection density at the lower end of the solid pattern printed area)]/(printing reflection density at the upper end of the solid pattern printed area)×100 (calculating formula)

### (6) Printing Test (Fogs in the Early Stage in N/N and H/H Environments)

The above-mentioned printer was charged with a toner and left in N/N environment for one day to measure a fog. Firstly, solid pattern printing with 0% printing density was performed with the printer and stopped halfway. After development, toner of a non-image areas on a photosensitive member was removed with a piece of an adhesive tape (product name: Scotch mending tape 810-3-18; manufactured by Sumitomo 3M Limited) and attached to a new printing paper to measure the color tone by means of a spectrophotometer (product name: SE-2000; manufactured by Nippon Denshoku Industries Co., Ltd.).

As a reference (or a benchmark sample), a new piece of adhesive tape was attached to the printing paper to measure the color tone in the same manner. Each color tone was referred as a coordinate of L*a*b* space and the chrominance ΔE was calculated from the color tones of the printing test sample and the benchmark sample to obtain a fog rate. As the for rate decreases, a fog gets smaller and image quality becomes more excellent.

In a similar manner, the printer was charged with a toner and left for 20 hours in H/H environment with a temperature of 30° C. and humidity of 80% to measure the fog thus occurred.

### (7) Dot Reproducibility

A 1 by 1 image (a pattern alternately repeating printing and non-printing areas dot by dot) was printed by means of the printer used in the above (5) and observation on 10 by 10 dots of the printed image (100 dots in total) was made with a microscope to obtain the percentage of dots reproduced precisely.

### <Method for Producing Charge Control Resin Composition>

### Production Example 1

100 parts of a charge control resin with a weight average molecular weight of 20,000 and a glass-transition temperature of 65° C., which was obtained by polymerization of 82 parts of styrene, 11 parts of butyl acrylate and 7 parts of 2-acrylamido-2-methylpropanesulfonate, was dispersed in a mixed solvent comprising 24 parts of methyl ethyl ketone and 6 parts of methanol, followed by mixing and kneading with a roller while cooling. When the charge control resin was wrapped around the roller, 100 parts of a cyan pigment of C.I. Pigment blue 15:3 (manufactured by: Clariant Corp.) was gradually added thereto and kneaded for one hour to produce a charge control resin composition. The roll gap was 1 mm in the early stage and then gradually widened. 3 parts of an organic solvent (a mixed solvent of toluene and methanol at a ratio of 4 to 1) and 3 parts of glycidyl methacrylate (GMA) were added to the charge control resin composition in several batches while carefully watching the mixing and kneading state of the charge control resin composition.

### Production Example 2

A charge control resin composition was obtained in the same manner as in the Production example 1 except that 1.5 parts of GMA was added instead of 3 parts of GMA added during kneading in the Production example 1.

### Production Example 3

A charge control resin composition was obtained in the same manner as in the Production example 1 except that GMA was not added in the Preparation example 3 though added during kneading in the Production example 1.

### EXAMPLES

### Example 1

Into an aqueous solution of 9.8 parts magnesium chloride (a water-soluble polyvalent metal salt) dissolved in 250 parts of ion-exchanged water, an aqueous solution of 6.9 parts sodium hydroxide (an alkali hydroxide metal) dissolved in 50 parts of ion-exchanged water was gradually added while stirring, thus prepared a magnesium hydroxide colloid (hardly water-soluble metal hydroxide colloid) dispersion.

After dissolving or dispersing 10 parts of a charge control resin composition obtained in the Production example 1 in 80.5 parts of styrene and 19.5 parts of butyl acrylate, 1.5 parts of t-dodecyl mercaptan, 0.4 part of divinylbenzene and 10 parts of dipentaerythritol hexamyristate were added therein followed by stirring and mixing, thus obtained a polymerizable monomer composition.

Separately, 2 parts of methyl methacrylate (a polymerizable monomer for shell), 0.1 part of zinc phthalocyanine and 100 parts of water were mixed and subject to finely-dispersing treatment by means of an ultrasonic emulsifying machine to obtain an aqueous dispersion of a polymerizable monomer for shell. As a result of measuring the particle diameter of a droplet of the aqueous dispersion by means of a particle size distribution measuring device (product name: SALD2000A; manufactured by Shimadzu Corporation), D90 was 1.7 μm.

The polymerizable monomer composition was charged into a magnesium hydroxide colloid dispersion thus obtained (the amount of colloid: 4.0 parts) and agitated until the droplet became stable. Thereafter, as a polymerization initiator, 6 parts of t-butylperoxy-2-ethylhexanoate (product name: PERBUTYL O; manufactured by NOF Corporation) was added followed by high shear stirring at 15,000 rpm by means of EBARA MILDER (product name: MDN303V; manufactured by Ebara Corporation), thus formed a droplet of the polymerizable monomer composition.

An aqueous dispersion of the droplet of the polymerizable monomer composition was charged into a reactor furnished with stirring vanes. The temperature of the reactor was raised to 90° C. to polymerize. When the polymerization conversion rate reached almost 100%, a reaction product formed in the reactor was sampled to measure the particle diameter of a particle to be a core layer. The result was 7.4 μm.

0.2 part of 2,2′-azobis(2-methyl-N(hydroxyethyl))-propion amide (product name: VA-086; manufactured by Wako Pure Chemical Industries, Ltd.) for a polymerization initiator for shell dissolved in the above-mentioned aqueous dispersion of the polymerizable monomer for shell and 65 parts of distilled water was charged into the above reactor. Further, polymerization reaction was continued at 90° C. for four hours and cooled with water to discontinue, thus obtained an aqueous dispersion of a colored particle having pH of 9.5.

While stirring the aqueous dispersion of a colored particle thus obtained at 25° C. for ten minutes, dilute sulfuric acid was added therein to be pH 5 or less and acid washing was performed thereto. After the mixture was dewatered by filtration, new ion-exchanged water was added by 500 parts to make the mixture slurry again followed by water washing. Dewatering and water washing were then repeated for several times. After separating solid content by filtration, the solid content was dried by a drier at 45° C. for two days and nights, thus obtained a dried colored particle.

As a result of measuring the dried colored particle, the volume average particle diameter “Dv” was 7.45 μm.

100 parts of the colored particle thus obtained and 0.6 part of silica (product name: RX-200; manufactured by: Nippon Aerosil Co., Ltd.), which was subject to hydrophobicity-imparting treatment, were mixed by means of a high-speed agitator (product name: HENSCHEL MIXER) to prepare a toner.

pH of a water extract of the toner thus obtained was 6.2. Evaluation of toner properties, an image formed with the toner and so on was carried out as mentioned above. The results are shown in Table 1.

### Example 2

A toner was obtained in the same manner as in Example 1 except that 10 parts of the charge control resin composition obtained in Production example 2 was used instead of 10 parts of the charge control resin composition obtained in Production example 1 used for preparing the polymerizable monomer composition in Example 1.

### Example 3

A toner was obtained in the same manner as in Example 1 except that 0.2 part of zinc phthalocyanine was used instead of 0.1 part of zinc phthalocyanine used for preparing the aqueous dispersion of polymerizable monomer for shell in Example 1.

### Example 4

A toner was obtained in the same manner as in Example 1 except that 10 parts of the charge control resin composition obtained in Production example 2 and 0.3 part of zinc phthalocyanine were used instead of 10 parts of the charge control resin composition obtained in Production example 1 used for preparing the polymerizable monomer composition and 0.1 part of zinc phthalocyanine used for preparing the aqueous dispersion of polymerizable monomer for shell respectively.

### Comparative Example 1

A toner was obtained in the same manner as in Example 1 except that 10 parts of the charge control resin composition obtained in Production example 3 and further 1 part of the charge control resin used in Production example 1 (that is, a charge control resin produced by polymerization of 82 parts of styrene, 11 parts of butyl acrylate and 7 parts of 2-acrylamido-2-methylpropanesulfonate) were dissolved or dispersed in 80.5 parts of styrene, 18.25 parts of butyl acrylate and 0.25 part of GMA, and zinc phthalocyanine was not added, instead of 10 parts of the charge control resin composition obtained in Production example 1 dissolved or dispersed in 80.5 parts of styrene and 19.5 parts of butyl acrylate for preparing the polymerizable monomer composition in Example 1.

### Comparative Example 2

A toner was obtained in the same manner as in Comparative example 1 except that 0.6 part of the charge control resin composition used in the Production example 1 was used and an acid washing was performed at 25° C. for seven and a half minutes instead of 1 part of the charge control resin used for preparing the polymerizable monomer composition in Production example 1 and the acid washing of the colored particle at 25° C. for ten minutes in Comparative example 1.

### Comparative Example 3

A toner was obtained in the same manner as in Comparative example 1 except that 0.8 part of the charge control resin used in the Production example 1 was used and an acid washing was performed at 25° C. for five minutes instead of 1 part of the charge control resin used for preparing the polymerizable monomer composition in Production example 1 and the acid washing of the colored particle at 25° C. for ten minutes in Comparative example 1.

### Comparative Example 4

A toner was obtained in the same manner as in Comparative example 1 except that 6 parts of the charge control resin composition obtained in Production example 3 was used, 0.4 part of the charge control resin used in Production example 1 was used and an acid washing was performed at 25° C. for one minute instead of 10 parts of the charge control resin composition obtained in Production example 3 and 1 part of the charge control resin used in Production example 1 used for preparing the polymerizable monomer composition and the acid washing of the colored particle at 25° C. for ten minutes in Comparative example 1.

### Comparative Example 5

A toner was obtained in the same manner as in Comparative example 1 except that 15 parts of the charge control resin composition obtained in Production example 3 was used, 1.4 parts of the charge control resin used in Production example 1 was used and an acid washing was performed at 25° C. for one minute instead of 10 parts of the charge control resin composition obtained in Production 3 and 1 part of the charge control resin used in Production example 1 used for preparing the polymerizable monomer composition and the acid washing of the colored particle at 25° C. for ten minutes.

### <Results>

Testing results are shown in Tables 1 and 2. Notations in the tables mean as follows.

*1) Abbreviations of the polymerizable monomers for binder resin and shell mean as follows.

ST: Styrene

BA: Butyl acrylate

DVB: Divinylbenzene

MMA: Methyl methacrylate

*2) Phr is a weight ratio of a colorant with respect to 100 parts of a binder resin for a core layer. In the weight of the binder resin for a core layer, however, a crosslinkable polymerizable monomer (a crosslinkable monomer) and a macromonomer type polymerizable monomer are not included.

For example, in the case of Example 1, Phr is calculated regarding the total amount of ST and BA as 100 parts and excluding a crosslinkable DVB component contained in a binder resin and MMA contained in a monomer for shell.

“Not measured” in Table 2 means that measurement was not carried out since the charge amount was excessively small and development on a photosensitive member was hardly completed.

TABLE 1

| | Example | Example | Example | Example | Comparative | Comparative | Comparative | Comparative | Comparative |
|---|---|---|---|---|---|---|---|---|---|
| | 1 | 2 | 3 | 4 | example 1 | example 2 | example 3 | example 4 | example 5 |
| Binder resin | ST/BA/DVB | Same as | Same as | Same as | ST/BA/GMA/DVB | Same as | Same as | Same as | Same as |
| (feed amount in | (80.5/19.5/0.4) | Example | Example | Example 1 | (80.5/18.25/0.25/0.4) | Comparative | Comparative | Comparative | Comparative |
| parts by | | 1 | 1 | | | example 1 | example 1 | example 1 | example 1 |
| weight) | | | | | | | | | |
| *1 | | | | | | | | | |
| Colorant | Cyan | Same as | Same as | Same as | Same as | Same as | Same as | Same as | Same as |
| | colorant | Example | Example | Example 1 | Example 1 | Comparative | Comparative | Comparative | Comparative |
| | PB 15:3 | 1 | 1 | | | example 1 | example 1 | example 1 | example 1 |
| Added amount | 5 Phr | Same as | Same as | Same as | Same as | Same as | Same as | Same as | Same as |
| of colorant | | Example | Example | Example 1 | Example 1 | Comparative | Comparative | Comparative | Comparative |
| (Phr) *2 | | 1 | 1 | | | example 1 | example 1 | example 1 | example 1 |
| Charge control | Production | Production | Same as | Production | Production | Production | Production | Production | Production |
| resin (CCR) | example 1 | example 2 | Production | example 2 | example 3 | example 3 | example 3 | example 3 | example 3 |
| composition | (10) | (10) | example 1 | (10) | (10) | (10) | (10) | (6) | (15) |
| (feed amount) | | | | | | | | | |
| (parts by | | | | | | | | | |
| weight) | | | | | | | | | |
| Feed amount of | 0 | 0 | 0 | 0 | 1 | 0.6 | 0.8 | 0.4 | 1.4 |
| separately | | | | | | | | | |
| added charge | | | | | | | | | |
| control resin | | | | | | | | | |
| (parts by | | | | | | | | | |
| weight) | | | | | | | | | |
| Aqueous | MMA + | Same as | MMA + | MMA + | MMA | Same as | Same as | Same as | Same as |
| dispersion of | zinc | Example | zinc | zinc | | Comparative | Comparative | Comparative | Comparative |
| polymerizable | phthalocyanine | 1 | phthalo- | phthalo- | | example 1 | example 1 | example 1 | example 1 |
| monomer for | (2/0.1) | | cyanine | cyanine | | | | | |
| shell (feed | | | (2/0.2) | (2/0.3) | | | | | |
| amount in parts | | | | | | | | | |
| by weight) | | | | | | | | | |

TABLE 2

| | | | | | Comparative | Comparative | Comparative | Comparative | Comparative |
|---|---|---|---|---|---|---|---|---|---|
| | Example 1 | Example 2 | Example 3 | Example 4 | example 1 | example 2 | example 3 | example 4 | example 5 |
| Work function X (eV) | 5.39 | 5.51 | 5.45 | 5.57 | 5.41 | 5.58 | 5.51 | 5.65 | 5.27 |
| Gradient A of Normalized | 11.5 | 16.7 | 14.1 | 17.2 | 7.3 | 12.4 | 11.5 | 25.2 | 12.91 |
| photoelectron yield (1/eV) | | | | | | | | | |
| Value (A-55X + 290) | 5.05 | 3.65 | 4.35 | 0.85 | −0.25 | −4.50 | −1.55 | 4.45 | 13.06 |
| Average circularity | 0.962 | 0.960 | 0.971 | 0.958 | 0.975 | 0.978 | 0.975 | 0.978 | 0.979 |
| pH of water extract | 6.2 | 5.9 | 6 | 5.9 | 5.9 | 4.9 | 5.2 | 3.9 | 3.9 |
| Dot reproducibility | 95 | 92 | 94 | 90 | 77 | 48 | 79 | 38 | 57 |
| (in the early stage) | | | | | | | | | |
| Reflection density in the | 1.34 | 1.32 | 1.35 | 1.32 | 1.26 | 1.18 | 1.29 | 1.4 | 0.97 |
| early stage of printing (N/N) | | | | | | | | | |
| Decreasing rate (%) of | 5 | 4 | 6 | 4 | 21 | 15 | 16 | 32 | 42 |
| reflection density in the | | | | | | | | | |
| early stage of printing | | | | | | | | | |
| (N/N) | | | | | | | | | |
| Reflection density in the | 1.37 | 1.39 | 1.38 | 1.38 | 1.43 | 1.29 | 1.38 | Not | 1.06 |
| early stage of printing | | | | | | | | measured | |
| (H/H) | | | | | | | | | |
| Fog in the early stage | 0.4 | 0.6 | 0.3 | 0.4 | 1.6 | 1.5 | 2.1 | 4 | 5.4 |
| (N/N) | | | | | | | | | |
| Fog in the early stage | 0.9 | 1.1 | 1.2 | 0.8 | 12.5 | 16.9 | 11.4 | Not | 7.5 |
| (H/H) | | | | | | | | measured | |

### <Summary of the Results>

Each of the toners obtained in Examples 1 to 4 has the following features: the work function X (eV) and the gradient A of the normalized photoelectron yield calculated from a formula (normalized photoelectron yield/excitation energy) are in the ranges of 5.35<X<5.60 and A−55X+290>0; the average circularity of the toner is in the range from 0.950 to 0.995; and pH of the water extract of the toner is in the range from 4 to 8. In the early stage of printing, each of the toners of Examples 1 to 4 is high in dot reproducibility and reflection density, and low in decreasing rate of reflection density, occurrence of fogs and changes in toner properties when left in N/N and H/H environments.

In contrast, each of the toners obtained in Comparative examples 1 to 3 has the work function X (eV) in the range of 5.35<X<5.60, however, a value calculated from the relational expression “A−55X+290” of the work function X (eV) and the gradient A of the normalized photoelectron yield is less than 0. In Comparative example 2, pH of the water extract of the toner is in the range from 4 to 8, however, the pH value is relatively low. In the early stage of printing, each of the toners of Comparative examples 1 to 3 is low in dot reproducibility and reflection density, and high in decreasing rate of reflection density and occurrence of fogs, particularly when left in H/H environment. Overall, insufficient printing density in the early stage of printing is remarkable.

Further, the work function X (eV) of the toner obtained in Comparative example 4 exceeds 5.60 and the work function X (eV) of the toner obtained in Comparative example 5 is less than 5.35. pH of the water extracts of the toners of Comparative examples 4 and 5 are less than 4 and excessively low. In comparison to the toners of Examples, the toners of Comparative examples 4 and 5 are lower in dot reproducibility and higher in occurrence of fogs in the early stage of printing, particularly when left in N/N environment. Overall, problems of fogs are remarkable.

1. A toner for developing an electrostatic latent image comprising a colored particle containing a colorant and a binder resin, wherein a work function X (eV) of the toner obtained in measuring work function and a gradient A (1/eV) of a normalized photoelectron yield with respect to an excitation energy calculated from a formula “normalized photoelectron yield/excitation energy” are in the ranges of 5.35<X<5.60 and A−55X+290>0.

2. The toner for developing an electrostatic latent image according to claim 1, wherein the colorant is a cyan colorant.

3. The toner for developing an electrostatic latent image according to claim 1, wherein an average circularity is from 0.950 to 0.995.

4. The toner for developing an electrostatic latent image according to claim 1, wherein pH of a water extract is from 4 to 8.

5. The toner for developing an electrostatic latent image according to claim 1, wherein the colored particle contains a charge control agent and the charge control agent is a charge control resin.

6. An image forming method comprising steps of:
a charging process to charge a photosensitive dram by a charging member;
an exposing process to form an electrostatic latent image on the photosensitive dram;
a developing process to develop the electrostatic latent image with a toner for developing an electrostatic latent image;
a transferring process to transfer the developed image on a recording medium; and
a fixing process to fix the transferred image on the recording medium,
wherein the toner for developing an electrostatic latent image comprises a colored particle containing a colorant and a binder resin, and a work function X (eV) of the toner in measuring work function and a gradient A (1/eV) of a normalized photoelectron yield with respect to an excitation energy calculated from a formula “normalized photoelectron yield/excitation energy” are in the ranges of 5.35<X<5.60 and A−55X+290>0.
